(19) United States
(12) Patent Application Publication
(10) Pub. No.: US 2015/0213063 A1
(43) Pub. Date: Jul. 30, 2015

(54) DATA STANDARDIZATION

(71) Applicant: LinkedIn Corporation, Mountain View, CA (US)

(72) Inventors: Navneet Kapur, Sunnyvale, CA (US); Gloria Lau, Los Altos, CA (US)

(73) Assignee: LinkedIn Corporation, Mountain View, CA (US)

(21) Appl. No.: 14/179,319

(22) Filed: Feb. 12, 2014

Related U.S. Application Data
(60) Provisional application No. 61/932,138, filed on Jan. 27, 2014.

(51) Int. Cl. G06F 17/30; H04L 12/18

(52) U.S. Cl. CPC G06F 17/30289; H04L 12/1813

(57) ABSTRACT

Disclosed in some examples are methods, systems, and machine readable mediums which automatically convert an unstandardized attribute value of a member profile of a social networking service to one of a plurality of standardized values for that attribute. In some examples, the method utilizes various matching and similarity metrics in combination with social aspects available to a social networking service to determine the best standardized value that matches the unstandardized value entered by the user.

### CLAIM OF PRIORITY

This patent application claims the benefit of priority, under 35 U.S.C. Section 119 to U.S. Provisional Patent Application Ser. No. 61/932,138, entitled “Data Standardization,” filed on Jan. 27, 2014 to Navneet Kapur and Gloria Lau, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass online, computer based services aimed at connecting friends and family (often referred to simply as “social networks”), as well as online, computer based services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a flowchart of a method of standardizing unstandardized values according to some examples of the present disclosure.

FIG. 2 shows a flowchart of a more detailed method of standardizing unstandardized values according to some examples of the present disclosure.

FIG. 3 shows a flowchart of a method of partial matching according to some examples of the present disclosure.

FIG. 4 shows a flowchart of a more detailed method of standardizing unstandardized values according to some other examples of the present disclosure.

FIG. 5 shows a flowchart of a method of partial matching according to some examples of the present disclosure.

FIG. 6 shows a diagram of a social networking system according to some examples of the present disclosure.

FIG. 7 shows a diagram of a machine according to some examples of the present disclosure.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social networking website or service. However, the applicability of the inventive subject matter is not limited to a social networking service.

A social networking service is an online service, platform and/or site that allows members of the service to build or reflect social relations amongst each other. Typically, members construct profiles, which may include various attributes and values for those attributes which describes a member or their activities. Attributes may include personal information such as the member's name, contact information, employment information, photographs, personal messages, status information, links to related content, blogs, and so on. As already noted, social networking services allow members to build or reflect social relations amongst each other. One way social networks facilitate this is by providing members with the ability to identify, and establish links or connections with other members. For instance, in the context of a business-oriented social networking service, a person may establish a link or connection with his or her business contacts, including work colleagues, clients, customers, personal contacts, and so on. With a personal social networking service, a person may establish links or connections with his or her friends, family, or business contacts.

A connection is generally formed using an invitation process in which one member “invites” a second member to form a link. The second member then has the option of accepting or declining the invitation. If the second member accepts the invitation, a connection is formed. In general, a connection or link grants an information access privilege, such that a first person who has established a connection with a second person is, via the establishment of that connection, authorizing the second person to view or access certain non-publicly available portions of their profiles which may include communications they have authored (e.g., blog posts, messages, “wall” postings, or the like). Of course, depending on the particular implementation of the social networking service, the nature and type of the information that is shared as a result of the information access privilege, as well as the granularity with which the access privileges may be defined to protect certain types of data may vary greatly.

Social networks may also allow members to build or reflect the social relations amongst members by providing them with the ability to subscribe or follow other members. A subscription or following model is where one member “follows” another member without the need for mutual agreement. Typically in this model, the follower is notified of public messages and other communications posted by the member that is followed. An example social networking service that follows this model is Twitter—a micro-blogging service that allows members to follow other members without explicit permission. Other, connection based social networking services also may allow following type relationships as well. For example, LinkedIn allows members to follow particular companies.

While a social networking services may be generally described in terms of typical use cases (e.g., for personal and business networking respectively), it will be understood by one of ordinary skill in the art with the benefit of Applicant's disclosure that these are the typical use cases and that a social networking service whose typical use case is for business purposes may be used for personal purposes (e.g., connecting with friends, classmates, former classmates, and the like) as well as, or instead of business networking purposes and a personal social networking service may likewise be used for business networking purposes as well as or in place of social networking purposes. Both a business oriented social networking service and a personal oriented social networking service are herein referred to as a “social networking service.”

As already noted, members of the social networking service may construct member profiles that may be wholly or partially authored by the members. Member profiles on social networking services may contain various member attributes. Attributes, when given values, describe facets corresponding to the member's offline or online life. Example attributes may include where the member went to high-school, college, graduate school, where they live, past and current employment, activities, skills they possess, people they are connected with and the like. At least some of these member attributes may be given values by the member manually during profile creation or editing. In some examples, some attributes may be entered as unstandardized values (e.g., free-text fields). That is, the member may type in whatever they wish and the data is presented as part of the member's profile. There is no effort to limit the value beyond certain basic constraints such as length constraints and constraining the input to a certain form, such as numeric or alphanumeric. These member profile attributes may be referred to as unstandardized member profile attributes.

Free text entry may be preferred over providing a more standardized data entry (such as a list of acceptable values) because generating an exhaustive list of acceptable values for every attribute may be very difficult. For example, in the case of a member profile attribute for a name of an institute of higher education attended by the member, the list of possible values may be quite large. The Department of Education estimates that there are 6,900 accredited colleges and universities in the United States alone; the list is bound to be much higher when a global view is taken, or non-accredited institutes of higher education are considered.

As the social network grows it may be desirable to analyze the values of various attributes of a member's profile. For example, it may be desirable to know which members went to certain schools, which members work at certain companies, or the like. The very nature of unstandardized attribute values creates problems for this subsequent data analysis. For example, finding commonalties between members, such as finding all the members who went to a particular school would result in an underrepresented set. This may be due to variations in naming convention (e.g., “Ohio State University,” vs. “The Ohio State” vs. “Ohio State”), misspellings, ambiguities (e.g., “University of Wisconsin” could refer to “University of Wisconsin—Madison” or “University of Wisconsin—Eau-Claire” or any other University in that system), or the like. Data analysis on standardized values is much easier.

One approach to resolve this conflict may be to start with an unstandardized attribute value entry for a time, and then transition to a standardized entry using a list of possible values for the attribute value developed based upon the library of values that users have previously entered in an unstandardized fashion (e.g., free text). For example, various text processing algorithms may be utilized to derive a standardized list of attribute values from the unstandardized values previously entered. Any new members may be required to choose one of the standardized list of attribute values. For these members, data analysis thus becomes easy. However, for old members the problem of analyzing the unstandardized data still exists. In some cases, this may constitute a sizeable proportion of members. One solution is to force the old members to re-enter this information in the new, standardized entry. This is not desirable as it is inconvenient for members.

Disclosed in some examples are methods, systems, and machine readable mediums which automatically convert an unstandardized attribute value of a member profile of a social networking service to one of a plurality of standardized values for that attribute. In some examples, the method utilizes various matching and similarity metrics in combination with social aspects available to a social networking service to determine the best standardized value that matches the unstandardized value entered by the user.

For convenience of description, an unstandardized member profile attribute may be an attribute in which a member is not restricted to a particular list of acceptable values, and in some examples, may enter any value subject only to constraints based upon the data format (e.g., data length and data type) used to store the attribute value, and in some examples, other minor integrity or verification checks. A standardized member profile attribute may be an attribute for which a member is restricted to selecting from one of a plurality of predetermined standardized values. An example standardized entry may include a drop down box in which a user selects from the list of standardized values.

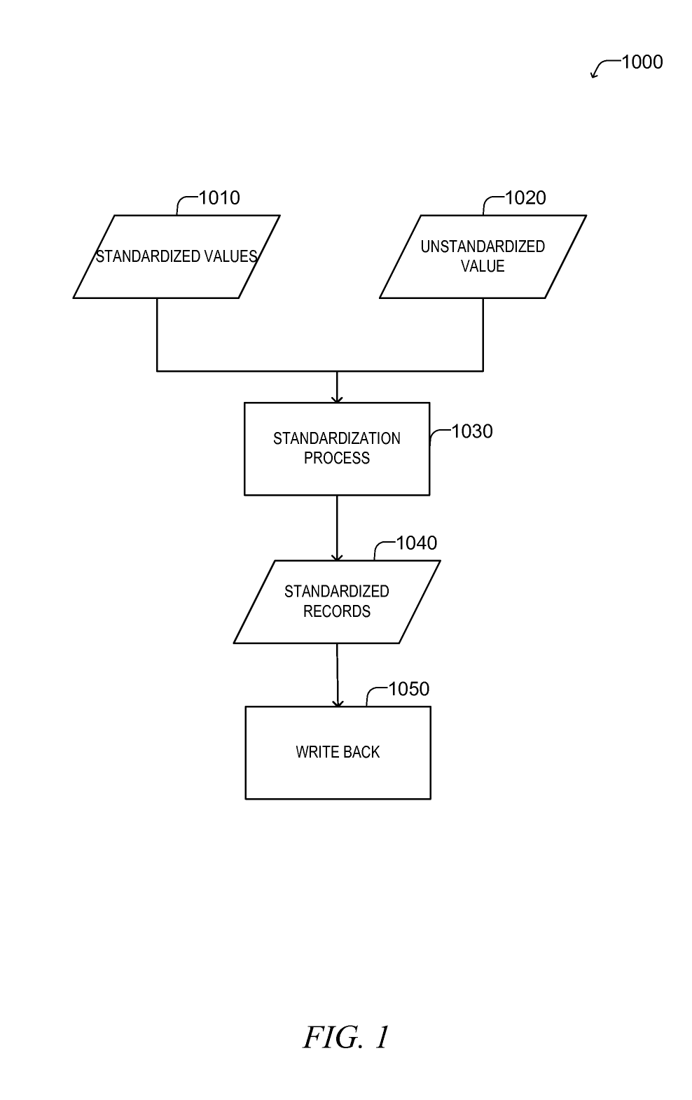

Turning now to FIG. 1, an example method 1000 of converting an unstandardized member profile attribute value to one of the predetermined standardized values is shown. Inputs such as the set of standardized values 1010 and the unstandardized value to standardize 1020 may be standardized by the standardization process 1030. Note that as used herein, the term “set” includes one or more members unless otherwise stated. Standardized values may include any set of one or more standard values for a member profile attribute and in some examples may include a standardized list of schools, a standardized list of degrees, a standardized list of fields of study, or the like. The input standardized values 1010 may be the list of acceptable values for the subject member profile attribute for which the unstandardized value corresponds. These inputs may be processed by the processor 1030 to produce a match to a standardized value 1040 which may be written back to the member's profile (e.g., may replace the unstandardized value for the subject member profile attribute) in a standardized form at operation 1050. In some examples, if the processor 1030 is not able to determine the standardized value, nothing is written back to the member profile, or a list of candidate standardized values may be presented to the member to allow the member to determine the standardized value, and the selected value may be written back to the member's profile.

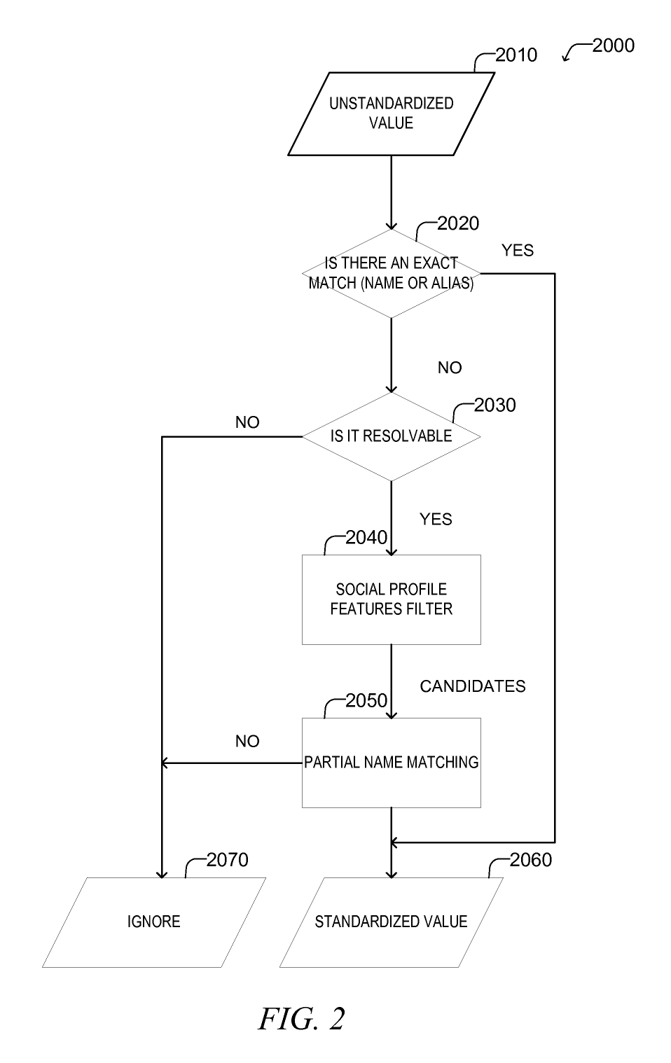

Turning now to FIG. 2 a flowchart of a method 2000 of processing the unstandardized member profile attribute values to match them with a standardized member profile attribute value is shown. In some examples, the processing steps shown in FIG. 2 may be performed in standardization process operation 1030 of FIG. 1. The unstandardized member profile attribute value for a particular subject member profile attribute is input at 2010. At operation 2020 the system checks for an exact match between the unstandardized member profile attribute value and one of the standardized member profile attribute values in the list of standardized member profile attribute values or a plurality of aliases for those standardized values for the subject attribute. For example, the “University of Minnesota” may have various commonly used aliases such as simply “Minnesota,” “University of Minnesota—Twin Cities,” “U of M Minneapolis,” or the like. If there is an exact match between either a standardized value or with one of its aliases, the corresponding standardized value is output at 2060. In some examples, exact matching may ignore case and punctuation. In some examples, the commonly used aliases may include common misspellings. In yet other examples, the unstandardized value 2010 may be cleaned prior to the process of FIG. 2. For example, the unstandardized value 2010 may be spell checked and automatically corrected as necessary.

Simply performing exact matching on values and their aliases may work for some members and for some attribute values, but may not achieve all the possible matches. For example, ambiguities may mean that a single unstandardized member profile attribute value could map to multiple possible selections. For example, the school name “UW” could map to the “University of Wisconsin—Madison,” “University of Wisconsin—Eau Claire,” “University of Washington,” or the like. Additionally, while the aliases may include common misspellings, members may have uncommon misspellings. In order to capture these, the system may utilize additional contextual clues and more advanced matching algorithms.

At operation 2030, the system may next filter out unresolvable values. Certain terms in the unstandardized member profile attribute value may inform the system that the value is likely unresolvable. For example, in the case of an educational institution member profile attribute, if the system is using a standardized list of institutes of higher education, but not attempting to standardize high-schools, the system may not attempt to standardized unstandardized values with the words “high-school” or “highschool” in it. In order to perform this filtering, the system may use a blacklist containing stop words. In some examples, if the unstandardized member attribute value contains one of the stop words in the blacklist, the entry may be considered unresolvable and subsequently the attribute may not be standardized at operation 2070.

If it is deemed resolvable, at operation 2040, the member's social network profile may be utilized to develop a list of potential candidates for a partial name matching operation. For example, the standardized values of the corresponding subject attributes in the profiles of a member's connections may be utilized to develop potential candidates. For example, if the subject profile attribute that the system is standardizing is the name of an educational institution the member has attended (e.g., a college or University), one or more of the educational institutes of the member's connections may be utilized as candidates.

In addition, in some social networking services, when a connection invitation is sent to another member the social networking system may ask the inviting member how she knows the invitee member (i.e., the member may provide a connection reason). For example, the inviting member may indicate that she knows the invitee member from common attendance at an educational institute, a common employer, or other ways. This may be used to refine the inclusion as candidates of attribute values from a member's connections. For example, instead of including all of the values of attributes of interest from a member's connections, the attribute values of only those attributes that are validated by the reason for the connection invitation may be utilized. In some other examples, the candidates may be weighted and those that are validated by the reason(s) for the connection invitation may be weighted higher than others. In some examples, the weights may be used to select a top set of candidates based upon a selection threshold. The selection threshold may be either a percentage (e.g., the top 10% of candidates), a minimum number of the top candidates (e.g., the top 20 candidates), or a minimum weight (all candidates above a particular weight are included).

Other social signals may be used. Many social networks store contact information for members. For example, many members utilize an email address with a domain portion that corresponds to various institutions, such as institutions of higher education, a company, or the like. The social networking service may have a list of email domains corresponding to the various institutions and the institution's standardized member profile attribute value. If a member, or a connection of the member, has a domain that corresponds to one of these institutions, the standardized member profile attribute value that corresponds to that institution may be utilized as a candidate.

Further signals may include groups that the member or their connections have joined, following relationships between the member or their connections, or the like. For example, if the member whose unstandardized value is being standardized follows a particular school, the particular school may be a candidate. Additionally, if one or more of the member's connections follow a particular school, then that particular school may be utilized as a candidate. Furthermore, if the member follows a second member, than the profile attribute values of the second member may be utilized the way that a connection's attribute values would.

In yet other examples, a first set of quick hints from the name itself may also be utilized to generate additional candidates. For example, if the school name is the attribute being standardized and the value given by a user contains the word “Santa,” the system may add the set of schools which contain the word “Santa” to the list of candidate schools. For example, the schools “Santa Clara University,” “UC Santa Cruz,” and so on. To calculate this, the system may employ an index, such as an index created from the set of standardized values that lists each standardized value indexed by each of the words that make it up. For example, the word “Santa” used as an index may return the values “Santa Clara University,” “UC Santa Cruz,” and all standardized values with the word “Santa” in it. This is similar to the positional inverted index discussed later but is position independent.

Additionally, a second set of quick hints the positioning of the words may be leveraged to generate even more candidates by utilizing the positional inverted index (described below in more detail). For example, if the school name given by the member contains “Santa” as the first word, the system may add to the candidate list of schools the set of schools in which “Santa” is the first word e.g., “Santa Clara University” and “Santa Monica College.”

These candidate standardized member profile attribute values may then be submitted for partial name matching at operation 2050. If a partial match is found with a high degree of confidence, then the value is considered standardized to the match and output at operation 2060. If the match has a low confidence, the value may not be standardized at operation 2070.

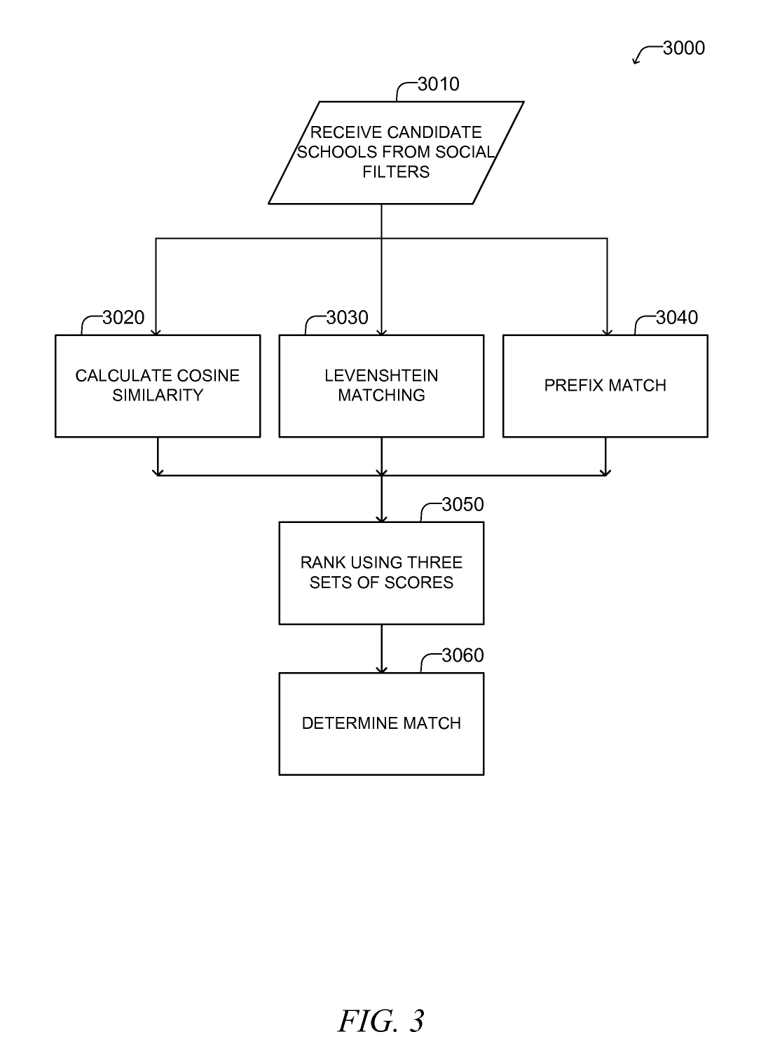

FIG. 3 shows a method 3000 of performing partial matching according to some examples of the present disclosure. At operation 3010 the candidate list of schools determined from the social features filter is input.

At operation 3020, the candidate schools are utilized to calculate a cosine similarity score using a cosine similarity algorithm. The cosine similarity is a bag of words algorithm that scores how closely an unstandardized value matches a candidate standardized value. The unstandardized value and the standardized candidate value are reduced to their constituent words. The set of all the words in both the unstandardized value and the candidate value is called the “dictionary.” Vectors are created for both the standardized and unstandardized value. Each vector is of dimension N where N is the number of unique terms in the dictionary. For each particular vector, the magnitude for each dimension may be calculated based upon a function of how many times the term corresponding to that dimension appears in the user entered value or standardized value that corresponds to that particular vector and a term frequency inverse document frequency metric for that term that scores the words higher if they are a rare term. A cosine is then calculated between the vector corresponding to the user entered value and the vector for the standardized values. This score provides a similarity metric for how close these terms are to each other. This process is then repeated for each of the rest of the candidate standardized values.

In some examples, the candidates for the cosine similarity algorithm may be all the set of candidate standardized values. In other examples, only the candidate values from the social features and the first set of quick hit candidates may be utilized (e.g., candidates derived from the name itself and not the candidates derived by utilizing the positional inverted index).

Because new or infrequently used terms are more important in the cosine similarity, this can lead to problems when members use terms not normally used to describe the attribute value. For example, if a member were to list an educational institution as “University of Cambridge, UK”—UK being the location of Cambridge—the presence of UK may lead to a low cosine similarity score for the correct result: University of Cambridge. This is because UK is likely to be an uncommon term and as a result, the td-idf score for UK may be very high. Consequently, the magnitude of the vector component dimension corresponding to the word “UK” for any unstandardized or standardized value with “UK” in it may be very high and since Cambridge University (the correct result) does not have “UK” in it, it may have a low magnitude for that dimension (likely 0) and as a result, the cosine similarity score between the unstandardized value and the correct result may be low. In order to correct for this, other metrics may also be used including Levenshtein matching and Prefix matching.

Certain words, such as “of,” are very common words. In some examples, in the various matching and partial matching algorithms, words such as “a,” “and,” “of,” and the like are not considered in determining a match or partial match for any of the algorithms. Note also that the term “University” is common as the first word in a standardized value for institutes of higher education and may return a potentially very large amount of results. In some examples, each term that is utilized to determine a prefix matching candidate may have to meet a threshold tf-idf score to avoid generating too many candidates.

Prefix matching at operation 3040 may score each standardized value based upon the ordering of the terms. Each candidate is compared word by word to the unstandardized input value. Each candidate standardized value is scored based on how many words match the unstandardized attribute value at the correct positions. For example, a standardized attribute value that matches a single term in the unstandardized attribute input would have a lower score than a standardized attribute value that matches two or more terms.

In some examples, the candidates for the prefix matching may be all the candidate standardized values. In other examples, the candidates may be the candidates identified through the social features and the second set of quick hint candidates (e.g., candidates identified by leveraging the position of a word (by using the positional inverted index and not candidates identified by the positional independent index).

A third partial matching algorithm, Levenshtein matching may be utilized at operation 3030. The Levenshtein score between the unstandardized input value and each candidate standardized value may be based on the minimum number of single-character edits (e.g., insertions, deletions, substitutions) needed to change one value into the other. A lower score means a better match.

In some examples, the candidates for the Levenshtein matching may be all the candidate standardized values. In other examples, some subset of the candidates may be utilized.

Once all three matching algorithms have been completed the scores for each of the algorithms may be combined into a single score for each of the standardized values at operation 3050. In some examples, the scores for each of the matching algorithms may be added together. In some examples, certain algorithms may be weighted higher than others. In these examples, the total score is the sum of each component score multiplied by the component weight. The individual scores may be normalized (e.g., to account for a case in which one algorithm outputs scores where higher scores indicate a better match and another algorithm produces lower scores to indicate a better match, and the like). The standardized values may be ranked and the highest ranked standardized value may be utilized as the output standardized value at operation 3060. If the most highly rated standardized value determined at operation 3060 scores high enough, the system may write back the standardized value to the member's profile. In other examples, highly ranked scores may be presented to the member for deciding.

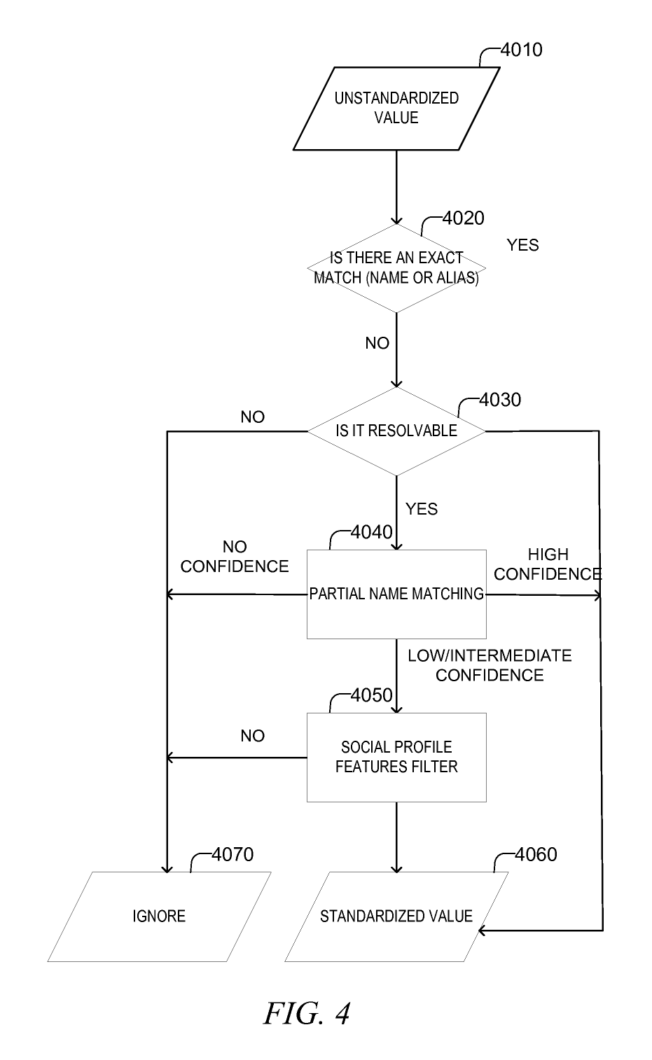

FIG. 4 shows a flowchart of a more detailed method of standardizing unstandardized values according to some other examples of the present disclosure. In the example of FIG. 4, the social profile features are not used to generate candidates for the partial name matching, but instead the social profile features may be utilized to confirm a partial match.

In some examples, the processing steps shown in FIG. 4 may be performed in standardization process operation 1030 of FIG. 1. The unstandardized member profile attribute value for a particular subject member profile attribute is input at 4010. At operation 4020 the system checks for an exact match between the unstandardized member profile attribute value and a combination of the list of standardized member profile attribute values and a plurality of aliases for those standardized values for the subject attribute as described earlier in reference to FIG. 2. If there is an exact match between either a standardized value or with one of its aliases, the corresponding standardized value is output at 4060. In some examples, exact matching may ignore case and punctuation. In some examples, the commonly used aliases may include common misspellings. In yet other examples, the unstandardized value 4010 may be cleaned prior to the process of FIG. 4. For example, the unstandardized value 4010 may be spell checked and automatically corrected as necessary.

At operation 4030, the system may next filter out unresolvable values as described in reference to FIG. 2. Certain terms in the unstandardized member profile attribute value may inform the system that the value is likely unresolvable. In order to perform this filtering, the system may use a blacklist containing stop words. In some examples, if the unstandardized member attribute value contains one of the stop words in the blacklist, the entry may be considered unresolvable and subsequently the attribute may not be standardized.

If it is resolvable, at operation 4040, the system may perform partial name matching. If the partial name matching 4040 produces a candidate standardized attribute value that has a high matching score, the system may select this candidate standardized value as the output at operation 4060. If the partial name matching 4040 produces only candidates (or no candidates) that have very low scores, the system may ignore the results at operation 4070. If the partial name matching 4040 produces one or more candidates with low or intermediate scores, then a social profile features filter may be employed at operation 4050 to confirm or exclude the candidate values. In some examples, the system may use a series of thresholds to determine whether to ignore the candidate standardized attribute value, accept the candidate standardized attribute value, or pass the candidate standardized attribute value to the social profile features filter for further scrutiny.

At operation 4050, those candidates needing confirmation or exclusion are evaluated using social profile features. These features may be the same features discussed with respect to FIG. 2, or different features. Each candidate is scored based upon how closely the candidate matches the social profile of the user. Certain social profile features may be worth more points or weighted higher than other social profile features depending on the perceived relative importance of the social profile feature.

For example, if the subject profile attribute that the system is standardizing is the name of an educational institution the member has attended (e.g., a college or University), for each connection of that member that lists the particular candidate standardized attribute value as their educational institution, the score of the candidate standardized attribute value may be increased.

In addition, in some social networking services, when a connection invitation is sent to another member the social networking system may ask the inviting member how she knows the invitee member (i.e., the member may provide a connection reason). For example, the inviting member may indicate that she knows the invitee member from common attendance at an educational institute, a common employer, or other ways. This may be used to increase the score of the matching candidate standardized attribute value.

Other social signals may be used. Many social networks store contact information for members. For example, many members utilize an email address with a domain portion that corresponds to various institutions, such as institutions of higher education, a company, or the like. The social networking service may have a list of email domains corresponding to the various institutions and the institution's standardized member profile attribute value. If a member, or a connection of the member, has a domain that corresponds to one of these institutions, the standardized member profile attribute value that corresponds to that institution may have its score increased.

Further signals may include groups that the member or their connections have joined, following relationships between the member or their connections, or the like. For example, if the member whose unstandardized value is being standardized follows a particular school, the particular school, if it is a candidate, may have its score increased. Additionally, if one or more of the member's connections follow a particular school, then that particular school, if it is a candidate, may have its score increased. Furthermore, if the member follows a second member, than the profile attribute values of the second member may be utilized the way that a connection's attribute values would.

Once the scores are calculated for each candidate standardized attribute value, the highest scoring standardized attribute value may be compared to a threshold to determine whether or not the social profile features filter “confirmed” the partial match and thus that standardized attribute value may be utilized as the standardized value at operation 4060, or whether the social profile features were not able to confirm any of the partial name matching candidates at operation 4070.

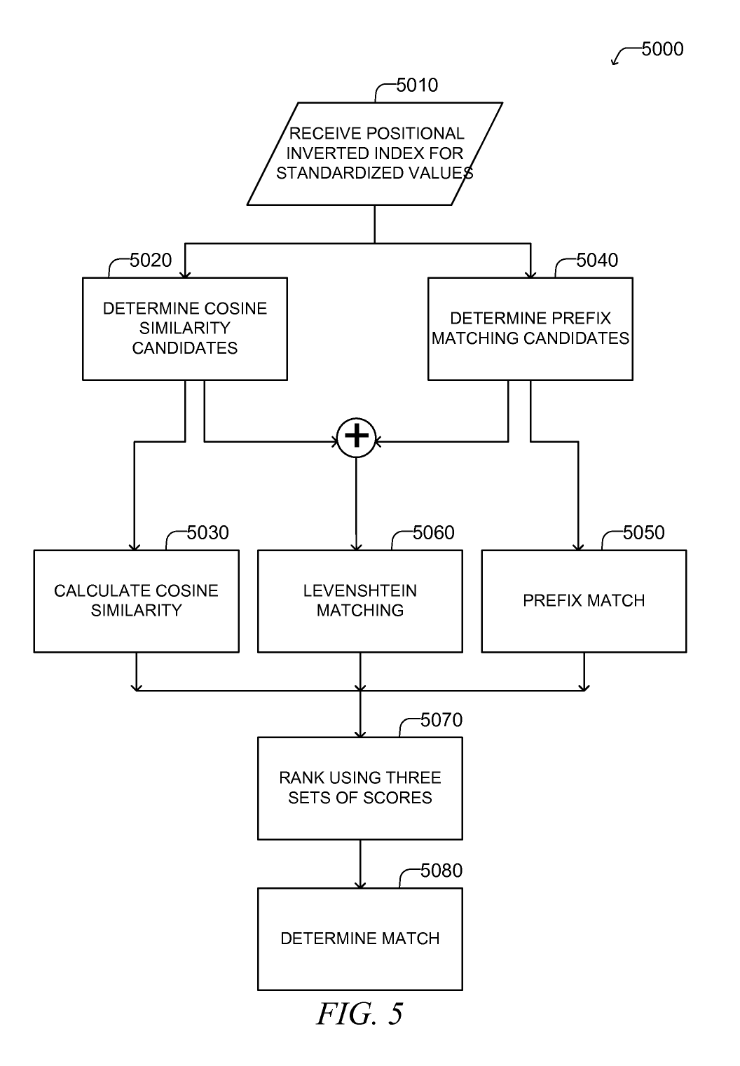

FIG. 5 shows a flowchart of a method of partial matching according to some examples of the present disclosure. Operations 5030, 5050, 5060, 5070, and 5080 are substantially the same as operations 3020-3060 from FIG. 3. The partial name matching in this embodiment as shown in FIG. 5 reflects that the social profile features have not already determined candidates for partial matching. While the system may perform cosine similarity 5030, Levenshtein matching 5060, and/or prefix matching 5050 on all the possible standardized attribute values, this may be computationally very expensive. Instead, in some examples, a set of candidate standardized attribute values are determined at operations 5020 and 5040.

At operation 5010, a positional inverted index of the standardized attribute values is input or created. In some examples, the positional inverted index is pre-computed and cached from the set of standardized attribute values. Different indices may be created for each attribute value being standardized. The positional inverted index is a table that lists all the standardized values indexed by a (word, position) pair. The word specifies a particular word and the position specifies the position within the standardized value in which the word must appear. For example, if the profile attribute is an educational institution, a partial positional inverted index may include:

| Word | Position | Standardized Values |
|---|---|---|
| “California” | 1 | “California University of Pennsylvania” |
| “California” | 3 | “University of California-Berkeley” |
| | | “University of California-Irvine” |
| | | “University of California-Los Angeles” . . . |
| . . . | . . . | . . . |

At operation 5020 a list of cosine similarity candidates may be determined. In some examples, the unstandardized member profile attribute value that is input into the partial name matching may be deconstructed into individual words. Words that are most important may be determined based upon their rarity in the positional inverted index (or some other text collection). For example, words such as “University” in the index for attributes describing higher education will have a high number of standardized profile attribute values with that word in at least one position. These terms are less important at finding a partial match than more specific terms that map to fewer standardized profile attribute values. One example algorithm that may be used to calculate term importance may be a term frequency inverse document frequency (tf-idf) algorithm. Candidates may then be selected by utilizing the list of standardized member profile attribute values that correspond to each term in the unstandardized value if the value has a tf-idf score above a predetermined threshold score.

For example, if the unstandardized attribute value is “Stanford University,” the candidates would be the set of standardized attribute values that have “Stanford” in any position in them. This can be obtained using the positional inverted index (note that the positional information is not utilized in the cosine similarity candidate selection). The word “University” is likely to have too low a tf-idf score as it is too common to be of importance. Thus the word “University” may not be used to select any candidates.

At operation 5030, the cosine similarity candidates are each scored using a cosine similarity algorithm as described with respect to operation 3030 of FIG. 3.

To form a candidate list for the prefix matching algorithm at operation 5040, the positional information of the positional inverted index may be utilized. The list of candidates may be the set of all standardized values that matches at least one word at the correct position in the unstandardized attribute value. So for example, if the attribute is a higher educational institution and the unstandardized attribute value is “University of Cambridge, UK,” the system would return a first set of schools that contained University AT position 1, a second set of schools that contained Cambridge AT position 2, and a third set of schools that contained UK AT position 3. The prefix matching candidates may be the union of sets 1, 2, and 3.

Certain words, such as “of,” are very common words. In some examples, in the various matching and partial matching algorithms, words such as “a,” “and,” “of,” and the like are not considered in determining a match or partial match for any of the algorithms. Note also that “University” AT the first position may return a potentially very large amount of results. In some examples, each term that is utilized to determine a prefix matching candidate may have to meet a threshold tf-idf score to avoid generating too many candidates.

At operation 5050, the prefix matching candidates determined at operation 5040 are scored using the prefix matching algorithm discussed with respect to operation 3040 in FIG. 3. At operation 5060, a set of candidates is scored using Levenshtein matching. The set of candidates scored depends on the particular implementation. In some examples, the set of cosine similarity candidates or prefix matching candidates that is the most extensive (e.g., biggest in size) is used. In yet other examples, the union or sum of the prefix matching candidates and cosine similarity candidates are used. Then, as described with respect to operations 3050 and 3060 of FIG. 3, the candidate scores are combined and normalized and the highest candidates are output at operation 5080.

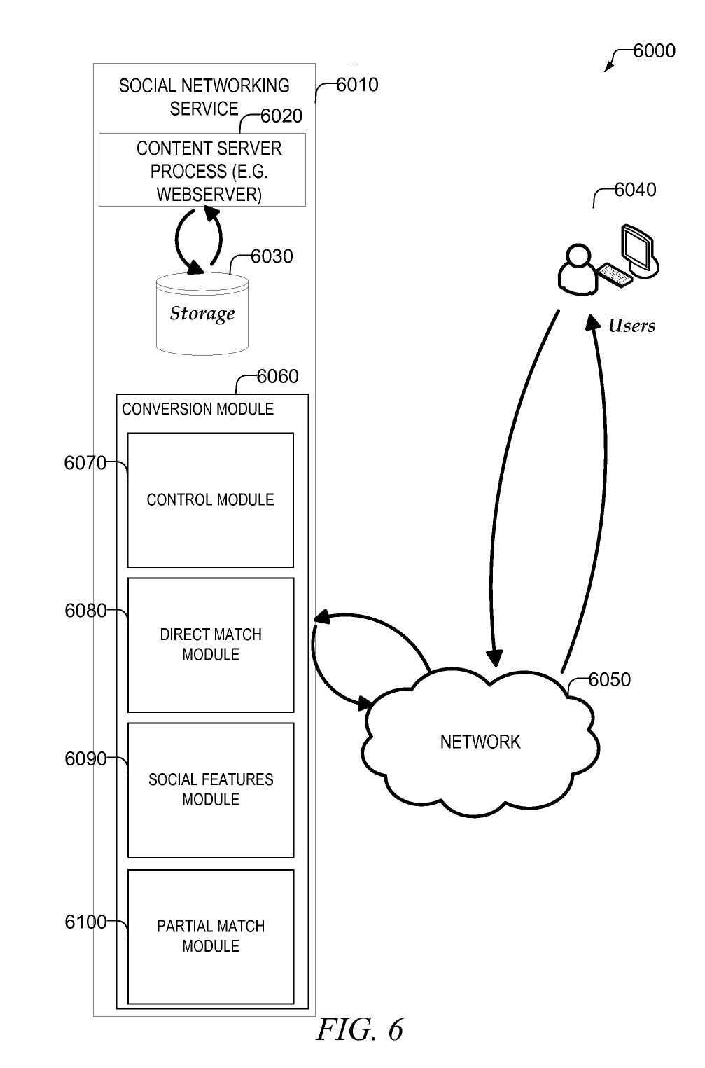

FIG. 6 shows an example system 6000 for providing a social networking service and for providing automatic conversion of an unstandardized attribute value to a standardized attribute value. Social networking service 6010 may contain a content server process 6020. Content server process 6020 may communicate with storage 6030 and may communicate with one or more users 6040 through a network 6050. Content server process 6020 may be responsible for the retrieval, presentation, and maintenance of member profiles stored in storage 6030. Content server process 6020 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 4040.

Users 6040 may include one or more members, prospective members, or other users of the social networking service 6040. Users 6040 access social networking service 6010 using a computer system through a network 6050. The network may be any means of enabling the social networking service 6010 to communicate data with users 6040. Example networks 6050 may be or include portions of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Conversion module 6060 may convert unstandardized profile attribute values into standardized profile attributes by matching the unstandardized value to one of a plurality of predetermined standardized attribute values as described above with respect to FIG. 1-5. The predetermined standardized attribute values may be predetermined based upon the plurality of unstandardized attribute values.

Conversion module 6060 may include control module 6070, direct match module 6080, social features module 6090, and partial match-module 6100. Control module 6070 may control the process by interacting with the direct match module 6080, social features module 6090, and partial match module 6100. Control module may parse through the member profiles stored in storage 6030 and retrieve the member profiles that have a selected member profile attribute value that is an unstandardized value for conversion to a standardized value. For each of the member profiles retrieved, the control module may execute the process described in FIG. 1-5. For example, the control module may try and determine if there is a direct match by calling direct match module 6080. Direct match module 6080 may attempt to match an unstandardized member profile attribute value to a standardized member profile attribute value by doing a direct comparison between the unstandardized member profile attribute value and the standardized member profile attribute value and a list of common aliases for that standardized member profile attribute value. If there is a direct match, the control module 6070 may save the standardized member profile attribute value to the member's profile.

If there is not a direct match, then the control module may utilize social features to narrow down the list of potential matches in the plurality of standardized attribute values for that attribute to use as input into a partial match module 6100. In some examples, the social features module 6090 may utilize social networking information to determine a candidate list. For example, signals about the proper standardized attribute value may be derived from the member profile of the member associated with the unstandardized attribute value. For example, email domain information, group affiliations, locations (e.g., where the member reports as having lived or worked presently or in the past), and the like. Other signals include member profile data corresponding to connections of the member. For example, the particular value of the (standardized or unstandardized) profile attribute of interest for the member's connections might suggest that the particular value may be relevant to the member. Other signals from connections include the connections email domain, membership in groups, attendance at universities, job status, employment history, or the like.

While in some examples, the social features module 6090 may suggest a list of candidates for a partial match module 6100, in other examples, the partial match module 6100 may run first (e.g., according to the description given with respect to FIG. 5) and if the partial match module 6100 has a strong match, the control module may simply accept the strongly matched standardized profile attribute value. If the partial module 6100 has one or more weak matches, the social features module 6090 may be used to select amongst the weak matches based upon a score calculated from the social signals. In some examples, the social features module 6090 may score the weak matches and if none of the weak matches scores higher than a predetermined threshold, then no standardized attribute value may be selected, otherwise, the highest scoring standardized attribute value may be used and written back to the member profiles.

Partial match module 6100 may build the positional inverted index, determine the cosine similarity and prefix matching candidates, score the candidates based upon one or more of cosine similarity, prefix matching, Levenshtein matching, or other text matching algorithms. If more than one text matching algorithm is utilized (as is shown in FIG. 3 and FIG. 5), the partial match module 6100 may combine the scores to form aggregate scores that are then output to the control module 6070. In some examples, if the partial match is done after the social features are considered, then the highest scoring match is used if it is above a predetermined partial match threshold score. If it is below the predetermined partial match threshold score, then the unstandardized value may not be automatically convertible to a standardized value.

Specific examples of member profile attributes that may be converted from an unstandardized value to a standardized value include names of educational institutions, a member's educational field of study or major (e.g., “Computer Science,” “Philosophy”), degree name (e.g., “Bachelors,” “Masters,” “Juris Doctorate,” “PhD,” “Doctorate,”), geographic location (e.g., city, territory, province, or the like), job titles, company names, or the like.

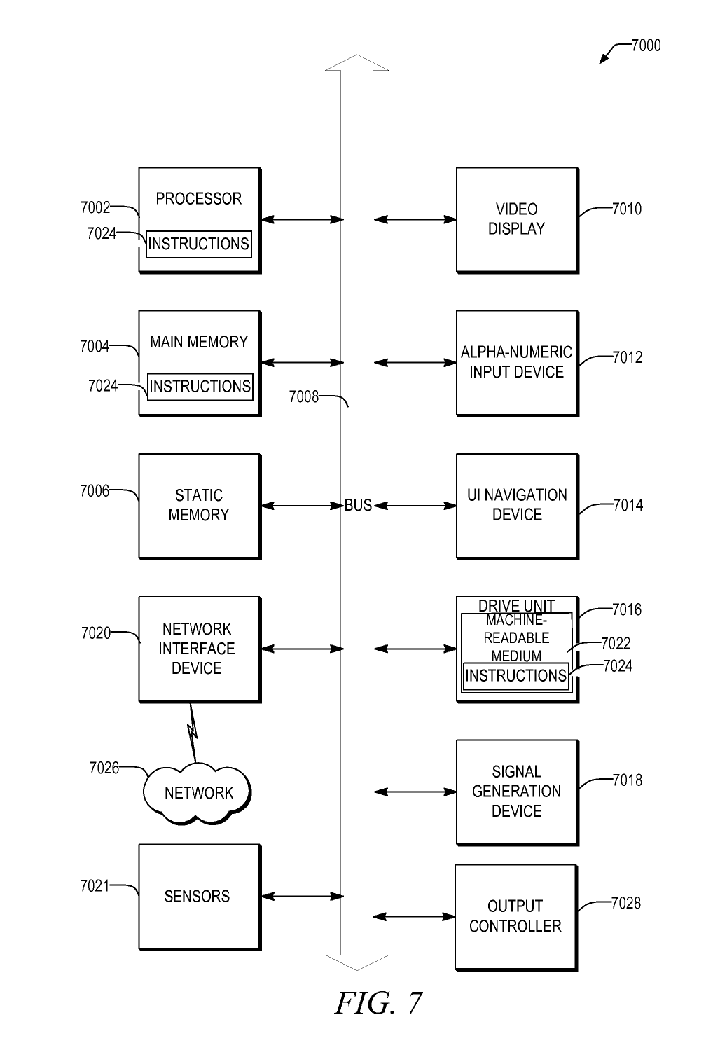

FIG. 7 illustrates a block diagram of an example machine 7000 upon which any one or more of the techniques (e.g., methodologies) discussed herein may perform. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 7000, and includes digital or analog communications signals or other intangible medium to facilitate communication of such software.

### OTHER NOTES AND EXAMPLES

Example 1 includes subject matter (such as a method, means for performing acts, machine readable medium including instructions that when performed by a machine cause the machine to perform acts, or an apparatus configured to perform) comprising: receiving an unstandardized attribute value describing an attribute of a social networking service user's member profile; receiving a plurality of predetermined standardized attribute values; determining if the unstandardized attribute value exactly matches one of the plurality of predetermined standardized attribute values; responsive to determining that the unstandardized attribute value does not exactly match one of the predetermined standardized attribute values, determining a set of candidate attribute values from the plurality of predetermined standardized attribute values based upon data describing social relations corresponding to the user; scoring the candidate attribute values based upon a partial matching algorithm, the partial matching algorithm scoring the candidate attribute values based upon how closely they match the unstandardized attribute value; and selecting one of the candidate attribute values based upon the candidate attribute value scores.

In example 2, the subject matter of Example 1 may optionally include, wherein the partial match algorithm comprises using a cosine similarity calculation.

In example 3, the subject matter of any one or more of examples 1-2 may optionally include wherein the partial match algorithm comprises using a prefix matching calculation.

In example 4, the subject matter of any one or more of examples 1-3 may optionally include, wherein the partial match algorithm comprises using a Levenshtein matching calculation.

In example 5, the subject matter of any one or more of examples 1-4 may optionally include wherein the partial match algorithm comprises using a cosine similarity calculation and one or more of a prefix matching calculation and a Levenshtein matching calculation and wherein scoring the candidate attribute values comprises combining the scores of the cosine similarity calculation and the one or more of the prefix matching calculation and the Levenshtein matching calculation.

In example 6, the subject matter of any one or more of examples 1-5 may optionally include wherein determining if the unstandardized attribute value exactly matches one of the plurality of predetermined standardized attribute values comprises determining if the unstandardized attribute value exactly matches one of the plurality of predetermined standardized attribute values and a plurality of aliases for each of the predetermined standardized attribute values.

In example 7, the subject matter of any one or more of examples 1-6 may optionally include, wherein data describing social relations corresponding to the user includes one or more of: a user's email domain, information in a member profile of a connection of the user's, a following relationship of the user, and a connection invitation reason.

In example 8, the subject matter of any one or more of examples 1-7 may optionally include, wherein the attribute is an educational institution.

In example 9, the subject matter of any one or more of examples 1-8 may optionally include wherein the attribute is a field of study.

Example 10 includes or may optionally be combined with the subject matter of any one of Examples 1-9 to include subject matter (such as a device, system, apparatus, or machine) comprising: a control module configured to: receive an unstandardized attribute value describing an attribute of a social networking service user's member profile; receive a plurality of predetermined standardized attribute values; a direct match module configured to: determine if the unstandardized attribute value exactly matches one of the plurality of predetermined standardized attribute values; a social features module configured to: determine a set of candidate attribute values from the plurality of predetermined standardized attribute values based upon data describing social relations corresponding to the user determine responsive to determining that the unstandardized attribute value does not exactly match one of the predetermined standardized attribute values; a partial match module configured to: score the candidate attribute values based upon a partial matching algorithm, the partial matching algorithm scoring the candidate attribute values based upon how closely they match the unstandardized attribute value; and wherein the control module is configured to select one of the candidate attribute values based upon the candidate attribute value scores.

In example 11, the subject matter of any one or more of examples 1-10 may optionally include, wherein the partial match module is configured to score the candidate attribute values based upon a partial matching algorithm comprising a cosine similarity calculation.

In example 12, the subject matter of any one or more of examples 1-11 may optionally include wherein the partial match module is configured to score the candidate attribute values based upon a partial matching algorithm comprising a prefix matching calculation.

In example 13, the subject matter of any one or more of examples 1-11 may optionally include, wherein the partial match module is configured to score the candidate attribute values based upon a partial matching algorithm comprising a Levenshtein matching calculation.

In example 14, the subject matter of any one or more of examples 1-13 may optionally include, wherein the partial match module is configured to score the candidate attribute values based upon a partial matching algorithm comprising a cosine similarity calculation and one or more of a prefix matching calculation and a Levenshtein matching calculation and wherein the partial match module is configured to score the candidate attribute values by being configured to at least combine the scores of the cosine similarity calculation and the one or more of the prefix matching calculation and the Levenshtein matching calculation.

In example 15, the subject matter of any one or more of examples 1-14 may optionally include, wherein the exact match module is configured to determine if the unstandardized attribute value exactly matches one of the plurality of predetermined standardized attribute values by at least being configured to determine if the unstandardized attribute value exactly matches one of the plurality of predetermined standardized attribute values and a plurality of aliases for each of the predetermined standardized attribute values.

In example 16, the subject matter of any one or more of examples 1-15 may optionally include, wherein data describing social relations corresponding to the user includes one or more of: a user's email domain, information in a member profile of a connection of the user's, a following relationship of the user, and a connection invitation reason.

In example 17, the subject matter of any one or more of examples 1-16 may optionally include, wherein the attribute is an educational institution.

In example 18, the subject matter of any one or more of examples 1-17 may optionally include wherein the attribute is a field of study.

What is claimed is:

1. A method comprising:
receiving an unstandardized attribute value describing an attribute of a social networking service user's member profile;
receiving a plurality of predetermined standardized attribute values;
determining if the unstandardized attribute value exactly matches one of the plurality of predetermined standardized attribute values;
responsive to determining that the unstandardized attribute value does not exactly match one of the predetermined standardized attribute values, determining a set of candidate attribute values from the plurality of predetermined standardized attribute values based upon data describing social relations corresponding to the user;
scoring the candidate attribute values based upon a partial matching algorithm, the partial matching algorithm scoring the candidate attribute values based upon how closely they match the unstandardized attribute value; and
selecting one of the candidate attribute values based upon the candidate attribute value scores.

2. The method of claim 1, wherein the partial match algorithm comprises using a cosine similarity calculation.

3. The method of claim 1, wherein the partial match algorithm comprises using a prefix matching calculation.

4. The method of claim 1, wherein the partial match algorithm comprises using a Levenshtein matching calculation.

5. The method of claim 1, wherein the partial match algorithm comprises using a cosine similarity calculation and one or more of a prefix matching calculation and a Levenshtein matching calculation and wherein scoring the candidate attribute values comprises combining the scores of the cosine similarity calculation and the one or more of the prefix matching calculation and the Levenshtein matching calculation.

6. The method of claim 1, wherein determining if the unstandardized attribute value exactly matches one of the plurality of predetermined standardized attribute values comprises determining if the unstandardized attribute value exactly matches one of the plurality of predetermined standardized attribute values and a plurality of aliases for each of the predetermined standardized attribute values.

7. The method of claim 1, wherein data describing social relations corresponding to the user includes one or more of: a user's email domain, information in a member profile of a connection of the user's, a following relationship of the user, and a connection invitation reason.

8. The method of claim 1, wherein the attribute is an educational institution.

9. The method of claim 1, wherein the attribute is a field of study.

10. A system comprising:
a control module configured to:
receive an unstandardized attribute value describing an attribute of a social networking service user's member profile;
receive a plurality of predetermined standardized attribute values;
a direct match module configured to:
determine if the unstandardized attribute value exactly matches one of the plurality of predetermined standardized attribute values;
a social features module configured to:
determine a set of candidate attribute values from the plurality of predetermined standardized attribute values based upon data describing social relations corresponding to the user determine responsive to determining that the unstandardized attribute value does not exactly match one of the predetermined standardized attribute values;
a partial match module configured to:
score the candidate attribute values based upon a partial matching algorithm, the partial matching algorithm scoring the candidate attribute values based upon how closely they match the unstandardized attribute value; and wherein the control module is configured to select one of the candidate attribute values based upon the candidate attribute value scores.

11. The system of claim 10, wherein the partial match module is configured to score the candidate attribute values based upon a partial matching algorithm comprising a cosine similarity calculation.

12. The system of claim 10, wherein the partial match module is configured to score the candidate attribute values based upon a partial matching algorithm comprising a prefix matching calculation.

13. The system of claim 10, wherein the partial match module is configured to score the candidate attribute values based upon a partial matching algorithm comprising a Levenshtein matching calculation.

14. The system of claim 10, wherein the partial match module is configured to score the candidate attribute values based upon a partial matching algorithm comprising a cosine similarity calculation and one or more of a prefix matching calculation and a Levenshtein matching calculation and wherein the partial match module is configured to score the candidate attribute values by being configured to at least combine the scores of the cosine similarity calculation and the one or more of the prefix matching calculation and the Levenshtein matching calculation.

15. The system of claim 10, wherein the exact match module is configured to determine if the unstandardized attribute value exactly matches one of the plurality of predetermined standardized attribute values by at least being configured to determine if the unstandardized attribute value exactly matches one of the plurality of predetermined standardized attribute values and a plurality of aliases for each of the predetermined standardized attribute values.

16. The system of claim 10, wherein data describing social relations corresponding to the user includes one or more of: a user's email domain, information in a member profile of a connection of the user's, a following relationship of the user, and a connection invitation reason.

17. The system of claim 10, wherein the attribute is an educational institution.

18. The system of claim 10, wherein the attribute is a field of study.

19. A machine readable medium that stores instructions which when performed by a machine, cause the machine to perform operations comprising:
receiving an unstandardized attribute value describing an attribute of a social networking service user's member profile;
receiving a plurality of predetermined standardized attribute values;
determining if the unstandardized attribute value exactly matches one of the plurality of predetermined standardized attribute values;
responsive to determining that the unstandardized attribute value does not exactly match one of the predetermined standardized attribute values, determining a set of candidate attribute values from the plurality of predetermined standardized attribute values based upon data describing social relations corresponding to the user;
scoring the candidate attribute values based upon a partial matching algorithm, the partial matching algorithm scoring the candidate attribute values based upon how closely they match the unstandardized attribute value; and
selecting one of the candidate attribute values based upon the candidate attribute value scores.

20. The machine-readable medium of claim 19, wherein the instructions for scoring the candidate attribute values based upon a partial match algorithm comprises instructions, which when performed by the machine, cause the machine to calculate a score using a cosine similarity.

21. The machine-readable medium of claim 19, wherein the instructions for scoring the candidate attribute values based upon a partial match algorithm comprises instructions, which when performed by the machine, cause the machine to calculate a score using prefix matching.

22. The machine-readable medium of claim 19, wherein the instructions for scoring the candidate attribute values based upon a partial match algorithm comprises instructions, which when performed by the machine, cause the machine to calculate a score using a Levenshtein matching calculation.

23. The machine-readable medium of claim 19, wherein the instructions for scoring the candidate attribute values based upon a partial match algorithm comprises instructions, which when performed by the machine, cause the machine to calculate a score using a cosine similarity calculation and one or more of a prefix matching calculation and a Levenshtein matching calculation and wherein the instructions for scoring the candidate attribute values comprises instructions, which when performed by the machine, cause the machine to combine the scores of the cosine similarity calculation and the one or more of the prefix matching calculation and the Levenshtein matching calculation.

24. The machine-readable medium of claim 19, wherein the instructions for determining if the unstandardized attribute value exactly matches one of the plurality of predetermined standardized attribute values comprises instructions, which when performed by the machine cause the machine to determine if the unstandardized attribute value exactly matches one of the plurality of predetermined standardized attribute values and a plurality of aliases for each of the predetermined standardized attribute values.

25. The machine-readable medium of claim 19, wherein data describing social relations corresponding to the user includes one or more of: a user's email domain, information in a member profile of a connection of the user's, a following relationship of the user, and a connection invitation reason.

26. The machine-readable medium of claim 19, wherein the attribute is an educational institution.

27. The machine-readable medium of claim 19, wherein the attribute is a field of study.
